(19) United States
(12) Patent Application Publication
(10) Pub. No.: US 2013/0197937 A1
(43) Pub. Date: Aug. 1, 2013

(54) Real time communicable disease information system and methodology

(71) Applicant: Lanette Andrea Coleman, Farmington Hills, MI (US)

(72) Inventor: Lanette Andrea Coleman, Farmington Hills, MI (US)

(21) Appl. No.: 13/385,092

(22) Filed: Feb. 1, 2012

(51) Int. Cl. G06Q 50/24

(52) U.S. Cl. 705/3

(57) ABSTRACT

A system 10 and a methodology 140 allowing the sexual health of an individual to be quickly and easily determined before a sexual or otherwise intimate encounter is consummated.

### FIELD OF THE INVENTION

The present invention relates to a real time communicable disease information system and methodology and more particularly to a system and a methodology which allows individuals to securely and dynamically access, in real time, sexually transmitted disease information about those who these individuals desire to have an intimate personally relationship or encounter with.

### BACKGROUND OF THE INVENTION

The proliferation of occurrences of sexually transmitted diseases has greatly increased in recent years along with the emergence of “drug resistant” and incurable types of sexually transmitted diseases. It seems that sexual and intimate encounters have become very hazardous activities. In spite of the huge risks of such encounters, they continue unabated, it seems.

While the government and other agencies promote safe sexual practices, in “the heat of the moment” such practices are either ignored or forgotten, especially if the participants have not planned for the activity and brought the necessary items. However, if the participants, in “real time” and during this “moment” had a way to quickly and easily determine whether their proposed “partner” has some sort of sexually transmitted disease, the proposed encounter could quickly be terminated and infection obviated.

There is such a need for a system and a methodology which allows for a quick and efficient determination of the presence of a sexually transmitted disease within a proposed partner before an intimate encounter is consummated or begun, thereby preventing infection. Such a need is met by the proposed inventions.

### SUMMARY OF THE INVENTION

It is a first non-limiting object of the present invention to provide a system and a methodology which allows for the quick and efficient determination, in real time, of the presence of a sexually transmitted disease within an individual.

It is a second non-limiting object of the present invention to reduce the likelihood of or prevent the occurrence of sexual transmitted diseases by providing disease status information to proposed sexual partners of an individual.

According to a first non-limiting aspect of the present invention, a communicable disease information system is provided and includes a database having identifying information associated with at least one individual and communicable disease test results associated with the at least one individual; and a portion which allows access to the communicable disease test result.

According to a second non-limiting aspect of the present invention, a communicable disease information system is provided and includes a database having identifying information associated with at least on individual and communicable disease test results associated with the at least one individual; a portion which allows real time access to the identifying information and the test results; a second portion which generates a first signal when at least one of the test results is of a positive state and which generates a second signal when all of the test results are of a negative state; and a responder which selectively receives the first and said second signals and which enters into a first operational state upon receipt of the first signal and which enters into a second operational state upon receipt of the second signal.

According to a third non-limiting aspect of the present invention, a method of promoting a safe sexual encounter is provided. The method includes the steps of creating identifying information of an individual; storing the identifying information of the individual; determining the sexually transmitted disease status of the individual; storing the determined sexually transmitted disease status of the individual; associating the stored and determined sexually transmitted disease status of the individual with the identifying information of the individual; allowing a second individual to make an inquiry as to the sexually transmitted disease status of the individual; and transmitting a first signal in response to said inquiry when the status is positive and transmitting a second signal in response to the inquiry when the status is negative.

These and other features, aspects, and advantages of the present inventions will become apparent from a reading of the following detailed description of the preferred embodiment of the inventions, including the subjoined claims, and by reference to the following drawings.

### BRIEF DESCRIPTION OF THE DRAWINGS

FIG. 1 is a block diagram of a database which may be used by the preferred embodiment of the invention.

FIG. 2 is a block diagram of a system made in accordance with the teachings of the preferred embodiment of the invention.

FIG. 3 is a flow chart illustrating the sequence of steps which are cooperatively associated with the methodology of the preferred embodiment of the invention.

FIG. 4 is a device made in accordance with the teachings of an alternate embodiment of the invention and which may be used in combination with a smartphone.

### DETAILED DESCRIPTION OF THE PREFERRED EMBODIMENT OF THE INVENTION

Referring now to FIG. 2, there is shown a system 10 which is made in accordance with the teachings of the preferred embodiment of the various inventions.

Particularly, system 10 includes a processor 12 which is operable under stored program control and which may, in one non-limiting embodiment of the invention, comprise a commercially available I7® type processor which is sold by the Intel Corporation of the United States of America. Other types of processors may be utilized. The system 10 further includes a memory assembly 14 which is coupled to the processor 12 by the bus 16. The memory assembly 14 stores various data, including but not limited to the operating code for the system 10, and such data is selectively readable by the processor 12, and other data may be selectively placed within the memory assembly 14 by the processor 12. The communication between processor 12 and memory assembly 14 is accomplished by bus 16.

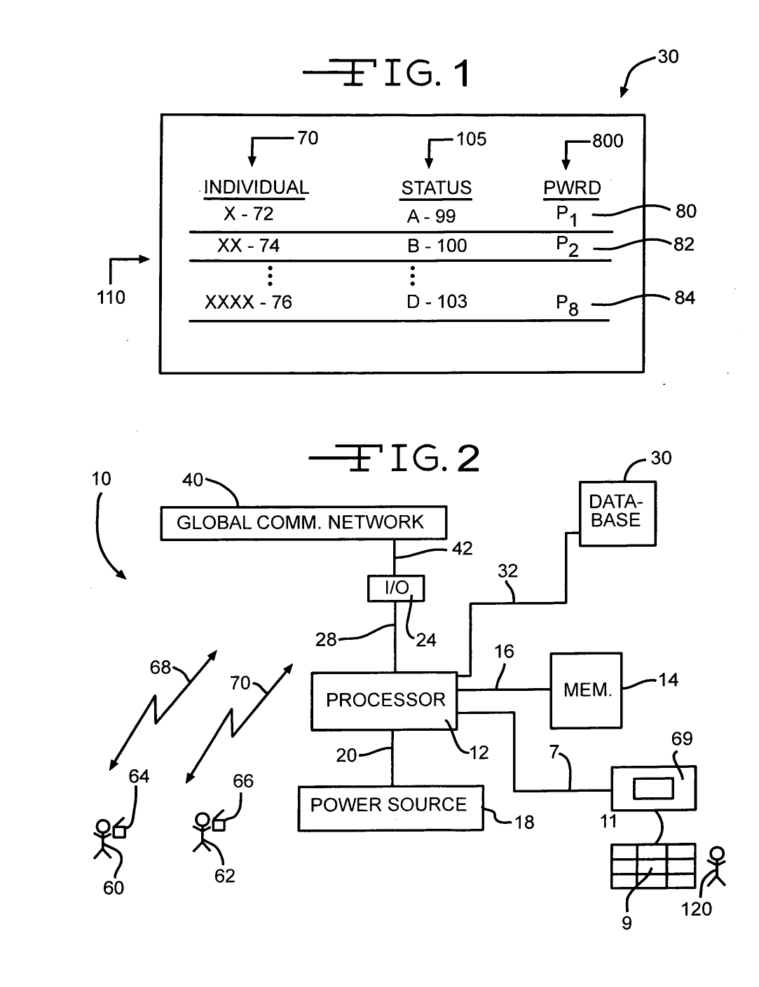

The system 10 further includes a source of electrical power or energy 18 which is coupled to the processor 12 by use of the bus 20 and which communicates operating electrical energy to the processor 12, by the bus 20, and such electrical energy may then be distributed to other elements within the system 10 by the processor 12. Further, the system 10 includes an input/output portion 24 which is coupled to the processor 12 by use of the bus 28 and which temporarily buffers data which emanates from the processor 12 or which is directed to the processor 12 and which facilitates communication between the processor 12 (the system 10) and other systems or processors or individuals/entities. The system 10 further includes a database 30 (which in one non limiting embodiment may reside within the memory assembly 14). The contents of the database 30 are described with respect to FIG. 1 and the database 30 is coupled to the processor 12 by use of the bus 32. Data which resides within the database 30 may be efficiently accessed by the processor 12 and the processor 12 may modify, delete, and/or add data to the database 30 by use of the bus 32. The input/output portion 24 is coupled to a global communications network or other types of networks 40 by the use of bus 42 and the input/output portion 24 allows the processor 12 to communicate with individuals and entities who have access to such networks, such as network 40. Non-limiting examples of such individuals includes, but is not limited to the individuals 60, 62 each having a respective “smartphone” 64, 66 which respectively communicate with the networks, such as network 40, by use of cellular telephone or radio frequency type signals 68, 70. Non-limiting examples of devices 64, 66 include that which is commonly referred to as a Blackberry® which is provided by Research In Motion in Canada and an Android® type device which is provided by various cellular telephone carriers in the United States of America.

The system 10 further includes a display 69 which is coupled to the processor 12 by bus 7 and a keyboard 9 which is coupled to the display 69 by bus 11 and which communicates with the processor 12 through the display 69. In this manner, an operator of system 10, such as operator 120, may input data, by use of keyboard 9, to the memory assembly 14 and/or to the database 30 and information from the processor 12, the memory assembly 14 and the database 30 may be communicated to the operator 120 once it is communicated to and displayed upon the display 69. The operator 120 may dynamically configure and modify the database 30 by the use of keyboard 9 and busses 11, 7, processor 12, and bus 32. Information may be placed upon the display 69 from the database 30 by bus 32 and 7 and processor 12.

Referring now to FIG. 1, there is shown the database 30 which is made in accordance with the teachings of the preferred embodiment of the invention. As shown, the database 30 includes a first data column 70 which is populated by the names of individuals, such as names 72, 74, and 76. To each name is given a respective password 80, 82, 84 which collectively reside in password column 88. To each name is also ascribed a status indicator, such as respective status indicators 99, 100, 103 which collectively reside within status column 105. Each row 110 of information in the database 30 therefore includes a password, such as password 80; the associated name or identity of an individual, such as name 72; and associated status indicator, such as indicator 99 which is either positive or negative. For an indicator, such as indicator 99 to be negative, then the sexually transmitted disease tests associated with the individual identified in the row in which that indicator resides have to be all negative for syphilis, gonorrhea, HIV, herpes, and chlamydia. If any of these tests are positive for any of these diseases than the status indicator is positive. For an individual, these tests can be manually reviewed by the operator 120 of system 10 and then that operator, such as operator 120, can manually cause the status indicator for that individual to be set in accordance with the aforementioned guidelines. Other types of diseases may also be tested and used to determine whether the status of an individual is “positive” or “negative”.

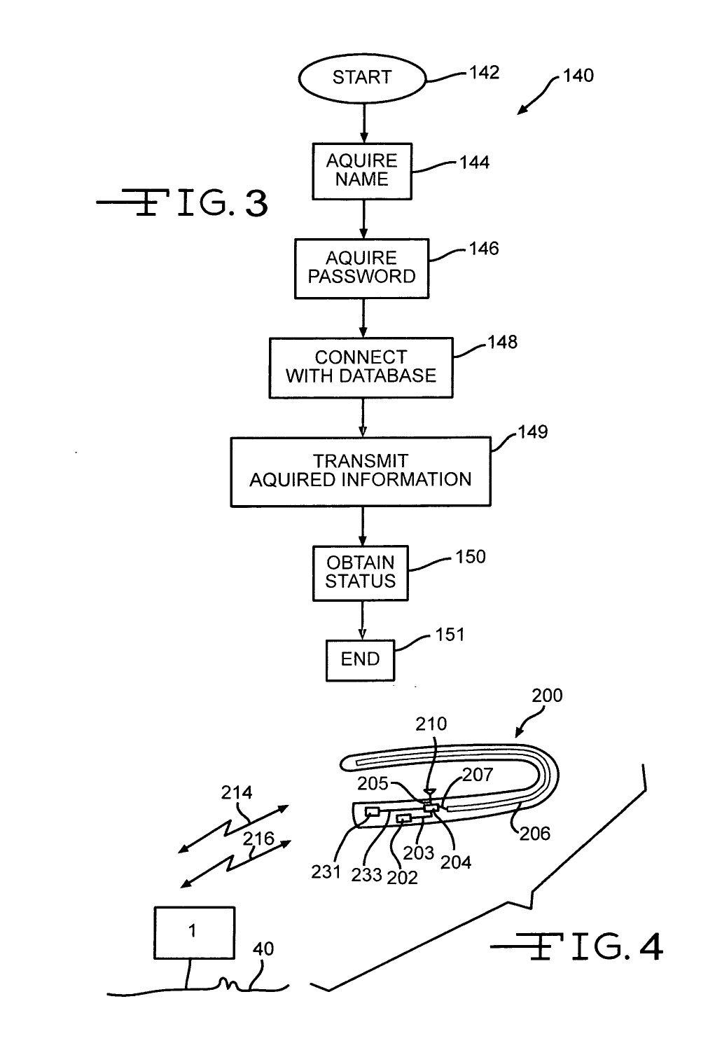

Referring now to FIG. 3, there is shown a flow chart 140 which describes the methodology of the preferred embodiment of the invention. Particularly, the methodology 140 begins with an initial step 142 in which it is determined, by one who desires to have a sexual or otherwise intimate encounter with an individual to see if it can be ascertained whether that individual has some sort of sexually transmitted disease. Importantly, this determination can be done in “real time” during the “heat of the moment” and right before the sexual activity begins. In step 140, it must be further ascertained whether that individual is an active member or participant of the system 10. If that individual is a member of the system 10, then step 144 follows step 142 and in step 144 the name of that individual is obtained. Step 146 follows step 144 and in step 146 the password of that individual is obtained. Step 148 follows step 146 and in step 148 the person who desires to have an encounter with the individual member of system 10 establishes a communications type connection with system 10, by use of a smartphone, such as smartphone 64, or some other device. Step 149 follows step 148 and in step 149 the person then transmits that individual's name and associated password to system 10 by the use of a smartphone, such as smartphone 64, or some other device through the previously established communications connection. Step 150 follows step 149 and in this step 150, the system 10 communicates the associated status of the individual to the requestor. Step 150 is then followed by step 151 denoting the end of the process 140.

In the foregoing manner, anyone seeking an intimate encounter with an individual can, in real time and during “the heat of the moment” seek and find the sexual disease status of that individual as long as that individual, for whom information is sought, pays money to have his or her data reviewed by the operator 120 and have a status placed within the database 30.

Referring now to FIG. 4, an alternate embodiment of the various inventions is shown. Particularly, a device, in the form of a bracelet 200 may be worn on the wrist of an individual. The bracelet 200 has a battery or source of electrical power 202 and a processor assembly 204 which is coupled to the source of electrical power 202 by the use of bus 203. The bracelet 200 further includes a selectively energizeable light array 206 which is coupled to the processor assembly 204 by the use of bus 207, and a transmitter/receiver assembly 210 which is coupled to the processor assembly 204 by bus 205 and which is coupled to the system 10 and which sends and receives receptive signals 214, 216 to and from the system 10 (e.g. to and from a router 1 which is coupled to network 40). The bracelet 200 further includes a switch 231 which is coupled to the processor assembly 204 by the use of bus 233. The processor assembly may include a processor and memory assembly such as processor 12 and memory assembly 14 and the code which controls the operator of the processor that is similar to processor 12 is stored within in the memory portion of the assembly 24.

In operation, upon selective depression or movement of the switch 231, the processor assembly 204 causes the interrogation signal 214 to the system 10 (i.e., to processor 12). Upon receipt of the signal 214, which has the password and the name of the individual wearing the bracelet (these items are stored within the assembly 204 (within the memory portion) and placed in the signal 214), the system 10 sends the signal 216 to the bracelet 200 and if the status is negative, the processor assembly 204 causes the light array 206 to receive power from the power source 202 to be lit (e.g. a green color) indicating that the wearer is most probably without some sort of sexually transmitted disease and those in close proximity to the wearer of the bracelet 200 can see that the wearer of the bracelet is healthy. Nothing in this description limits the item 200 to a specific shape and other shapes may be utilized. Bracelet 200 is therefore a transponder which selectively emits interrogation signal 214 and receives legit activation signal 216. The lighted device 200 therefore eliminates the need for further verification efforts and lets all those in close proximity to the wearer of the bracelet 200 that the wearer is free from disease of the sexually transmitted type. The bracelet structure may be replaced by any other desired structure.

It is to be understood that the present inventions are not limited to the exact construction or embodiment which have been delineated above but that various changes and modifications may be made without departing from the spirit and the scope of the inventions as they are more fully delineated in the following claims.

What is claimed is:

1) A communicable disease information system comprising a database having identifying information associated with at least one individual and communicable disease test results associated with said at least one individual; and a portion which allows access to said communicable disease test result.

2) A communicable disease information system comprising a database having identifying information associated with at least on individual and communicable disease test results associated with said at least one individual; a portion which allows real time access to said identifying information and said test results; a second portion which generates a first signal when at least one of said test results is of a positive state and which generates a second signal when all of said test results are of a negative state; and a responder which selectively receives said first and said second signals and which enters into a first operational state upon receipt of said first signal and which enters into a second operational state upon receipt of said second signal.

3) A method of promoting a safe sexual encounter, said method comprising the steps of creating identifying information of an individual; storing said identifying information of said individual; determining the sexually transmitted disease status of said individual; storing said determined sexually transmitted disease status of said individual; associating said stored and determined sexually transmitted disease status of said individual with said identifying information of said individual; allowing a second individual to make an inquiry as to the sexually transmitted disease status of said individual; and transmitting a first signal in response to said inquiry when said status is positive and transmitting a second signal in response to said inquiry when said status is negative.

4) The method of claim 3 further comprising the steps of issuing a transponder to said second individual; causing said transponder to receive said first and second signals; and causing said transponder to enter a first operational state in response to the receipt of said first signal and to enter a second operational state in response to the receipt of a second signal.
